(19) United States
(12) Patent Application Publication
(10) Pub. No.: US 2013/0065428 A1
(43) Pub. Date: Mar. 14, 2013

(54) ELECTRONIC DEVICE AND METHOD OF DETECTING A PROPER CABLE CONNECTION

(71) Applicants: Ryan David STEEVES, Kitchener (CA); Mohamad El-Hage, Cambridge (CA)

(72) Inventors: Ryan David STEEVES, Kitchener (CA); Mohamad El-Hage, Cambridge (CA)

(73) Assignee: RESEARCH IN MOTION LIMITED, Waterloo (CA)

(21) Appl. No.: 13/231,256

(22) Filed: Sep. 13, 2011

(51) Int. Cl. H01R 3/00

(52) U.S. Cl. 439/488

(57) ABSTRACT

An electronic device, systems and methods are described for detecting whether there has been a proper cable connection when a plug is inserted into a socket. A pressure sensor configured to measure air pressure within the socket generates one or more pressure signals as a function of the air pressure, and a processor determines whether a proper cable connection has been made (whether the plug has been fully inserted into the socket) as a function of the pressure signals.

### FIELD

The present disclosure relates generally to electrical or optical cable connectors. More particularly, the present disclosure relates to an electronic device and method of detecting a proper cable connection.

### BACKGROUND

As more and more people have access to electronic portable devices (such as mobile phones, PDAs, handheld televisions, mobile DVD and music players), different accessories that complement these devices have also been created. Some of these accessories are connected to the portable electronic device via a set of connectors. Such connectors are often referred to conventionally as “plug” and “socket.” In a typical implementation, a plug is properly connected to a socket by fully inserting the plug into the socket. Once the connection is established, power, signals or other information can be passed from a device to an accessory (or vice versa) electromagnetically or optically, often without need of a wireless communication channel. If a plug is not fully inserted into a socket, false positives, or misleading feedback, may result. In general, false positives and misleading feedback refer to a situation in which a plug is not fully inserted into the socket (and as a result, not all electrical or optical connections between the plug and the socket are properly established), but in which a user may assume or wrongly conclude that the plug is fully inserted.

### BRIEF DESCRIPTION OF THE DRAWINGS

Embodiments of the present disclosure will now be described, by way of example only, with reference to the attached Figures.

FIG. 1 is an isometric view of an illustrative portable electronic device;

FIG. 2 is a schematic of a system for detection of a proper cable connection;

FIG. 3A is a view of an illustrative plug and socket and associated apparatus;

FIG. 3B is a view of a portable electronic device, illustrating a cable connection; and

FIG. 4 is a flowchart of an example method of detection of a proper cable connection.

Other aspects and features of the present disclosure will become apparent to those ordinarily skilled in the art upon review of the following description of specific embodiments in conjunction with the accompanying figures.

### DETAILED DESCRIPTION

Described below are apparatus, systems and methods by which a portable electronic device may determine that a plug is fully inserted in a socket. Importantly, the concepts are not limited to use with a portable electronic device, but may be applied to devices that are less apt to be moved from place to place, such as large-display televisions; but the concepts are well illustrated and potentially advantageous in the context of a portable electronic device. In the discussion that follows one of the connecting components, typically the part that includes one or more protrusions and that is inserted into a receptacle will be called the “plug.” The concepts may be explained in terms of a plug that includes one or more substantially cylindrical pins, but the concepts are not necessarily limited to that conformation. “Plug” is used herein to encompass a variety of connectors having at least one male connecting part, such as a pin or prong.

Similarly, the receiving connector will be called a “socket.” Generally speaking, the socket is sized and shaped to receive the plug. The plug and socket will be described in an arrangement in which the socket is a part of a portable electronic device, and is substantially mounted on or affixed to the portable electronic device. The plug will be described in the context of an accessory (such as headphones) that a user may physically couple to the portable electronic device by insertion of the plug into the socket. When the plug and socket are properly connected, electrical or optical connections (or both) between the plug and the socket are properly established. “Socket” is used herein to encompass a variety of connectors that mate with plugs. Typically, the plug is “less fixed” than the socket, in that the plug typically is the element that is manipulated by a human being into a “more fixed” socket, but the concepts are not limited to this typical case. Furthermore, the concepts described herein may be applied to connectors that have male and female connective parts.

In the illustrative apparatus described below, electrical or optical information may be conveyed to or from the plug by a wire-like element, which will be called the “cable.” The cable may convey, for example, electrical power, electrical signals or optical signals, or any combination thereof. Although the socket will not be depicted as being coupled to a cable, the concepts may apply to embodiments in which the socket has a cable but the plug does not, or where the socket and plug both have cables. The illustrative apparatus will depict a portable electronic device such as a music player or a smart phone (having a socket), which is to be properly connected to headphones (having a cable and a plug), but the concepts disclosed herein are not limited to that particular apparatus.

When a plug is fully and correctly inserted into a socket such that the electrical or optical connections between the plug and the socket are properly established, that may be referred to as a “proper cable connection.” A proper cable connection may enable an electrical connection (by which electric power or electric signals may be conveyed) or an optical connection (by which optical power or optical signals may be conveyed) or both. Conventional plug-socket apparatus may include a mechanical switch (often in the socket) that may be configured to change its state (e.g., from open to closed or vice versa) depending upon whether the plug is properly connected to the socket. Such switches (which typically include moving parts) may suffer from wear and tear and may require repairs. The concepts described herein may supplement or supplant such mechanical switches.

Generally, the present disclosure provides an electronic device, system and method of detecting a proper cable connection between a plug and a socket, such as (but not limited to) an electrical connection between a portable electronic device and a headset. In one embodiment, the present disclosure provides for a pressure sensor to be attached to a socket or a plug. As will be described, the system supports one or more optional checks, by which the proper cable connection may be verified.

In an aspect there is provided an electronic device including: a socket for receiving a plug; a pressure sensor located in the socket configured to generate a pressure signal; and a processor operatively connected to the pressure sensor, the processor configured to determine whether there has been a proper cable connection as a function of the pressure signal.

In another aspect there is provided a method including: controlling a sampling of an air pressure inside a socket at a first sampling frequency; receiving a first pressure signal as a function of the air pressure; in response to the first pressure signal, controlling the sampling of the air pressure inside the socket at a second sampling frequency; receiving a plurality of pressure signals at the second sampling frequency; and determining when a proper cable connection of the socket and a plug has been made as a function of the plurality of pressure signals.

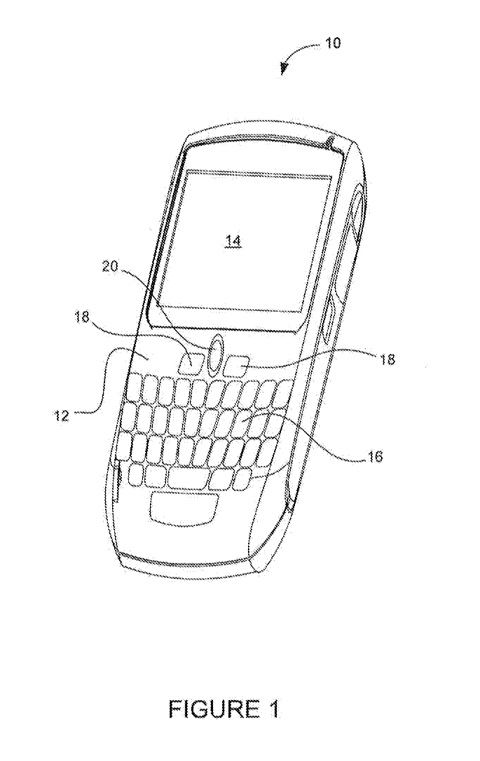

FIG. 1 illustrates a portable electronic device 10 such as a mobile communication device. The portable electronic device 10 has a body 12, which generally serves as a structural framework for other components. The portable electronic device 10 also includes a display screen 14, a keyboard/keypad 16, a set of buttons 18 and an input device such as a pointing device 20, which may be a trackball, joystick, scroll wheel, roller wheel, touchpad or the like. The portable electronic device may include one or more speakers (not shown). The portable electronic device 10 also includes a socket (not shown in FIG. 1), which may receive a plug. For purposes of illustration, the plug will be part of a headset or headphones (also not shown in FIG. 1). The portable electronic device 10 may handheld, that is, sized to be held or carried in a human hand.

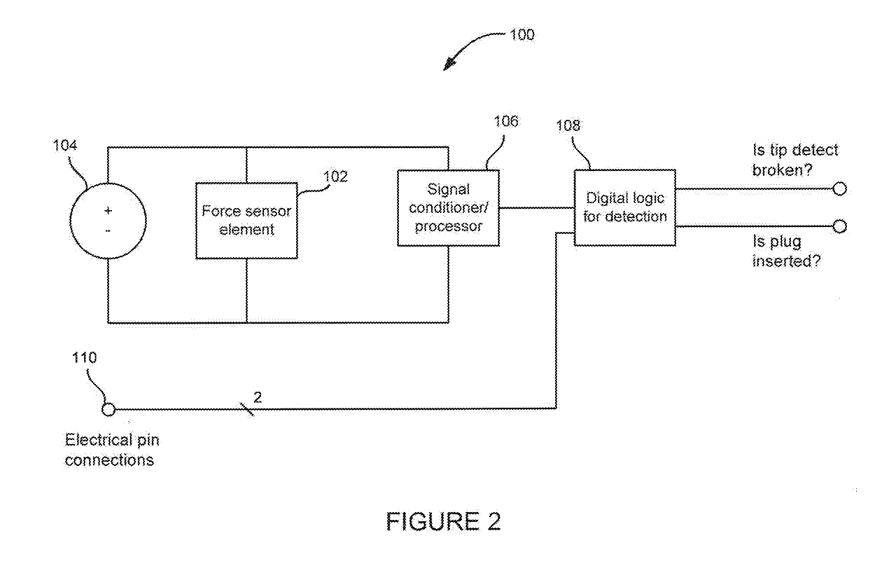

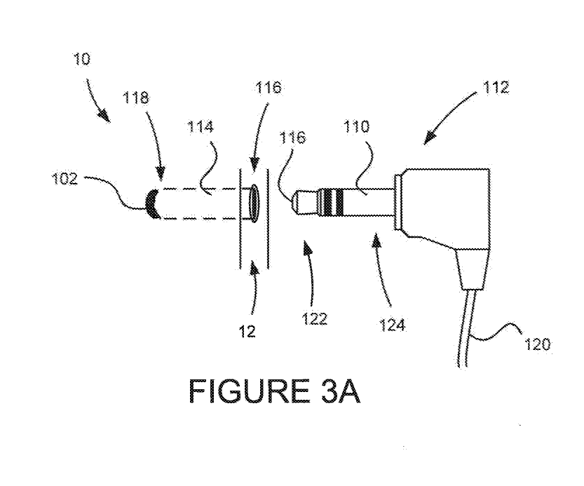

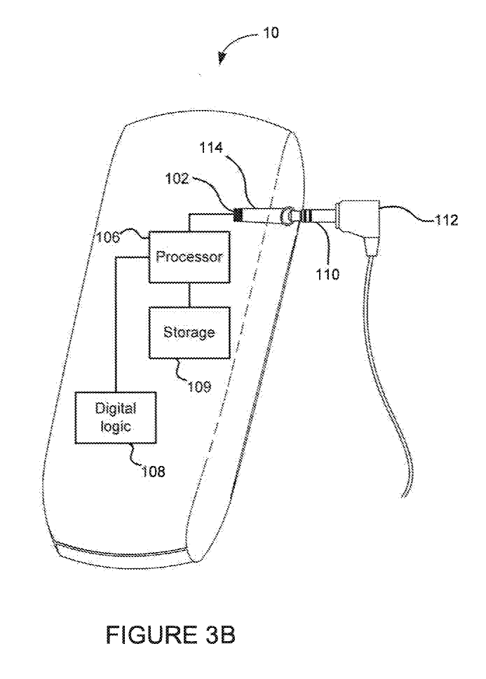

FIG. 2 illustrates a schematic diagram of a system 100 for detecting a proper cable connection. FIGS. 3A and 3B illustrate the system 100 for detecting a proper cable connection with reference to the portable electronic device 10. FIG. 3A shows an illustrative plug 112 and socket 114. The plug 112 is connected to a cable 120. The plug 112 includes a pin 110, which is a protruding member to be inserted into the socket 114. The socket 114 is sized and shaped to receive the pin 110. The socket 114 has a proximal end 116, where there is an opening in the housing 12 to receive the pin 110, and a distal end 118. When the plug 112 is fully inserted into the socket 114, a tip 116 of the pin 110 is proximate to or in contact with the distal end 118 of the socket 114. The socket 114 may include one or more electrical or optical connection points in any of several configurations, but these connection points are not depicted in FIGS. 2, 3A or 3B. As described below, two such connection points may come in contact with the pin 110, at different sites that will be called the inner pin 122 and the outer pin 124.

In the illustrative embodiment of FIGS. 2, 3A and 3B, a pressure sensor 102 is included in the socket 114, and is located near (or proximate to) the distal end 118 of the socket 114. In an alternative configuration, the pressure sensor 102 may be located elsewhere proximate to the socket 114, and in another embodiment, the pressure sensor may be located on or proximate to the tip 116 of the plug 112. The pressure sensor 102 may be any kind of pressure sensor, such as a microelectromechanical system (MEMS) pressure sensor (for example, a silicon MEMS pressure sensor). Typically the pressure sensor 102 may be a transducer that receives pressure as an input and generates an electrical pressure signal as an output. The pressure sensor 102 is operatively connected to a processor 106. As used herein, “operatively connected” indicates that the components can function in concert. Components may be operatively connected even though they are not abutting or proximate to or physically connected to one another. In the embodiment of FIGS. 2 and 3B, the pressure sensor 102 may be operatively connected to the processor 106 via, for example, internal wiring or cabling. Alternatively, the pressure sensor 102 and the processor 106 may be operatively connected by a wireless communication link. In the illustrative embodiment of FIGS. 2 and 3B, the processor 106 may be operatively connected to a digital logic component 108. The digital logic component 108 may be another kind of processor. While the processor 106 may be a general-purpose processor that monitors or controls many of the operations or functions of the portable electronic device, the digital logic component 108 may be a specialized processor that performs processing related to insertion of the plug 112 into the socket 114. In some embodiments, the functions of the processor 106 and the digital logic component 108 may be combined into a single element. In additional variations, the pressure sensor 102 itself may include processing capability, such as the ability to determine whether a sensed pressure exceeds a threshold, or how a pressure may be measured in units. The processor 106 may retrieve instructions from a storage component 109 such as non-volatile memory.

As illustrated in FIG. 2, the pressure sensor (or force sensor element) 102 may be operatively connected to a voltage bias 104, via for example internal wiring in the portable electronic device. The voltage bias may be AC or DC, depending on the pressure sensor 102 being used. In one embodiment, the voltage bias is provided by a power source internal to the portable electronic device 10, such as a rechargeable battery. In general, a voltage bias may make the pressure sensor 102 able to operate, and able to generate a pressure signal as a function of air pressure (which may include generating a pressure signal as a function of a pressure differential or a change in pressure).

The digital logic component 108 may be configured to determine, as a function of air pressure or contact pressure (as sensed by the pressure sensor 102), whether the plug 112 is fully and correctly inserted into the socket 114. In one illustrative embodiment, the processor 106 may receive a cable connection signal from the digital logic component 108. The cable connection signal indicates whether or not there has been a proper cable connection. A proper cable connection might not exist when (for example) the tip 116 of the plug 112 is broken or if the plug 112 is not fully inserted.

In one embodiment, the digital logic component 108 receives as an input a pressure signal from the pressure sensor 102. The digital logic component 108 may receive the pressure signal from the pressure sensor 102 directly, or may receive a pressure signal via an intermediate element. The digital logic component 108 may determine whether a sensed pressure exceeds a threshold. In some embodiments, the digital logic component 108 may receive further inputs from which it may determine whether or not there has been a proper cable connection. As mentioned previously, connection points in the socket 114 may come in contact with the inner pin 122 and the outer pin 124. The resistance between the inner pin 122 and the outer pin 124 may be tested or measured, and the resistance supplied as an input to the digital logic component 108. If contact is made by both the inner pin 122 and the outer pin 124, then the inner pin 122 and outer pin 124 may register a short or closed circuit connection, or a resistance that is zero or near-zero, which may indicate that the plug 112 is fully inserted in the socket 114. In the event the resistance between the inner pin 122 and the outer pin 124 is not near zero, but is instead large (in this context, a large resistance can be on the order of just a few ohms), a less-than-full insertion may be indicated. A very large resistance (e.g., on the order of 1000 ohms or more) may indicate, for example, that there has been nothing near a full insertion. In a variation, the resistance between the inner pin 122 and the outer pin 124 may be tested or measured by a validating component other than the digital logic component 108, such as resistance tester that is neither digital nor includes logical elements. The digital logic component 108 (or other validating component) may supply a resistance signal to the processor 106 as a function of the resistance between the inner pin 122 and the outer pin 124

In an illustrative embodiment discussed in more detail below, the digital logic component 108 is configured to test the resistance between the inner pin 122 and the outer pin 124, and does not receive or process other inputs.

In one embodiment, a mechanical tip detection switch (not shown) may be located within the portable electronic device. As noted previously, the concepts described herein may operate in concert with such a switch. The state of the switch may be a further input to the digital logic component 108. In an additional embodiment, it may be possible for the digital logic component 108 to determine whether the mechanical tip detection switch may be broken or non-functional.

As shown in FIGS. 3A and 3B, the pressure sensor 102 may be located at the distal end 118 of the socket 114. The pressure sensor 102 may be, for example, a silicon pressure sensor, a micro-electric mechanical system (MEMS), an ink pressure sensor or the like and may be calibrated to sense contact pressure, standard air pressure or to respond to changes in air pressure. In some embodiments, the pressure sensor 102 may be configured to generate a pressure signal as a function of air pressure in the socket 114. The pressure signal may be a function of, for example, the magnitude of air pressure, the magnitude of the change in air pressure, the abruptness of the change (e.g., whether a pressure change is more spike-like). In some embodiments, the pressure sensor 102 may be programmed to measure air pressure in units such as Torr or kilopascals, or in units of force (such as Newtons) applied to an area.

When the plug 112 is inserted into the socket 114, air in the socket 114 is displaced. Some of the air may escape from the socket 114 by leaking around the pin 110 and escaping the socket 114 near the proximal end 116. Insertion of the plug 112 into the socket 114 generally does cause, however, an increase in air pressure within the socket 114. The more quickly the plug 112 is inserted, the more abrupt the change in air pressure may be and perhaps the higher the magnitude of the change.

In one embodiment, the pressure sensor 102 may be calibrated to detect whether the pressure exerted by the insertion of a jack or object into the connector is above a pressure threshold. In general, the threshold separates pressures that are insignificant from those that may be significant. For example, the pressure sensor 102 may be configured such that, in the event the pressure is not above the threshold, the pressure sensor 102 will not generate a pressure signal. In the event the pressure sensor 102 detects the air pressure value to be over the pressure threshold, the pressure sensor 102 may generate a pressure signal. The pressure signal may be received by the processor 106. The pressure threshold may be an absolute pressure (in relation to a perfect vacuum). The threshold may be set to be in the range of (for example) 3 to 20 Newtons, or 4 to 15 Newtons. The pressure signal may act as an interrupt, such that a pressure signal triggers an interrupt event with respect to the processor 106. The pressure sensor 102 may be programmed to sample the air pressure at particular intervals, for example every millisecond or every second, and thereby generate a plurality of pressure signals. In another alternative, the pressure sensor 102 may sample at a sampling frequency controlled by the processor 106 (for purposes of illustration, it will be assumed that the sampling frequency is under the control of the processor 106). In a further alternative, the pressure sensor monitors pressure continuously. In still a further embodiment, the pressure sensor 102 does not apply a threshold, but the processor 106 compares a received pressure signal to a threshold to determine if the pressure signal is significant or valid.

In the event the processor 106 receives a valid pressure signal indicating that the contact pressure or air pressure detected by the pressure sensor 102 is beyond a threshold, the processor 106 may send a control signal to the digital logic component 108, in response to which the digital logic component 108 may determine the resistance between the inner pin 122 and the outer pin 124. If the resistance is approximately zero, that state is communicated by the digital logic component 108 to the processor 106. The pressure signal may indicate that the plug 112 has been inserted into the socket 114, and the resistance reading may support the conclusion that the plug 112 has been fully inserted into the socket 114. Based upon the pressure signal and the resistance reading, the processor 106 may determine that the plug 112 is fully inserted. In another embodiment, the processor 106 may receive the pressure signal from the pressure sensor 102 and, solely as a function of the pressure signal, determine that the plug 112 is fully inserted in the socket 114. In other words, checking the resistance is optional and may serve as a redundant check in order to further reduce the chances of a false positive.

In another embodiment, the pressure sensor 102 may be programmed to determine or respond to transient or rate-of-change results. In this variation, a pressure signal may be generated in response to a change in pressure. Similar to the embodiments in which the pressure sensor 102 responds to magnitudes of air pressure and contact pressure, changes in air pressure may be compared to a threshold to differentiate between changes that are insignificant and changes that may be significant. Similar to embodiments described earlier, a pressure signal caused by a change in pressure may result in an interrupt with respect to the processor 106.

In the course of experimentation, it was learned that multiple pressure readings could yield more accurate results than a single reading. Further, it was learned that a change in air pressure may yield a more accurate or useful signal than a magnitude of pressure. In addition, it was discovered that more accurate or useful results could be obtained by changing the sampling frequency. For example, the pressure sensor 102 may be sampling pressure at a first sampling frequency under the direction of the processor 106, such as every tenth of a second (10 Hz). When the pressure sensor 102 detects an abrupt change in air pressure, the pressure sensor 102 may continue to monitor the changing air pressure, and the processor 106 may increase the sampling frequency to a second sampling frequency (e.g., to 100 Hz or 1000 Hz). As a result, the processor 106 may receive a plurality of additional pressure signals (more closely spaced in time), and may monitor the change in pressure more frequently. The processor 106 may return to the first sampling frequency after a short interval of time. The processor 106 may analyze the pressure changes, as indicated by the pressure signals. An abrupt, spike-like change in the pressure may indicate that the plug 112 has been inserted into the socket 114. (If the changes in pressure were to be represented graphically as a curve, the shape of the curve or the spike that may signify insertion of the plug 112 into the socket 114 may vary from plug to plug and from socket to socket). Whether the pressure signals indicate that the plug 112 has been inserted into the socket 114 may be determined by any technique, such as curve-matching or mathematical correlation between a range of expected pressure signals and actual pressure signals.

The processor 106 may perform a redundant resistance check (e.g., via the digital logic component 108) to verify whether the plug 112 is fully inserted. If the resistance is large, the processor 106 may generate a feedback message to the user, thereby informing the user that the plug 112 has not been fully inserted in the socket. The feedback message may be conveyed visually (e.g., by text presented on display 14), audibly (e.g., a message or alarm announced by a speaker) or tactilely (e.g., by causing the portable electronic device 10 to vibrate), or any combination thereof. If the resistance is found to be large, monitoring of the air pressure may continue (e.g., at the first or second sampling frequencies) to determine whether the pressure continues to change (which may indicate, for example, a second insertion attempt). If the resistance is found to be very large, the processor 106 may determine that that there has been no actual insertion, and the pressure measurements can be disregarded as a false positive.

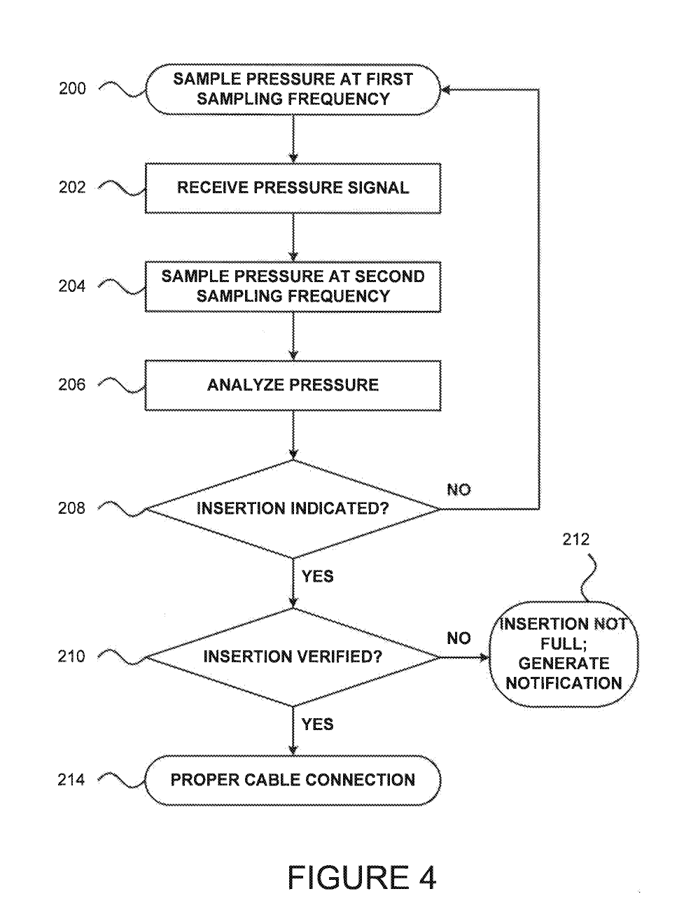

FIG. 4 illustrates a flowchart for one example method of detection of a proper cable connection of a plug 112 into a socket 114. For purposes of illustration, it will be assumed that the method is carried out by the processor 106, although the concept may also be applied to embodiments in which various functions are performed by or in concert with other components. At the outset, the processor 106 may control the pressure sampling 200 at a first sampling frequency. When the plug 112 is inserted into the socket 114, the pressure sensor 102 may detect a change in air pressure and may generate a pressure signal, which is received 202 by the processor 106. The pressure sensor 102, or the processor 106, or both, may determine whether the change in pressure is significant (e.g., by comparison of the change in pressure to a threshold). Assuming the change is significant, the processor 106 may control the pressure sampling 204 at a second sampling frequency, the second sampling frequency being higher than the first. In this way, the processor 106 receives a plurality of pressure signals. The processor 106 analyzes the pressure signals 206 to determine whether the pressure signals indicate 208 an insertion of the plug 112 into the socket 114. In the event the pressure signals do not correspond to an insertion, the processor 106 may return the pressure sampling to the first frequency 200. In the event, however, that insertion is indicated, the processor 106 may (optionally) verify the insertion 210, for example, by checking the resistance between the inner pin 122 and the outer pin 124 via digital logic component 108. In the event the insertion is not verified (or in the event a proper cable connection is lacking), the processor 106 may generate a notification to the user 212. In the event full insertion is verified, the processor 106 may proceed as though there has been a proper cable connection 214. When there has been a proper cable connection 214, the processor 106 may perform any number of functions consistent with that condition. For example, in the case where the plug 112 is attached by the cable 120 to a headset, the processor 106 may change the volume settings of the audio output. The processor 106 may change the sampling frequency, e.g., returning to the first sampling frequency or suspending pressure sampling while the plug 112 is inserted in the socket 114.

One or more of the above embodiments may realize one or more benefits. Various embodiments may provide a system for detecting a proper cable connection that is reliable and small. In the context of a handheld device, where space and weight are typically controlled commodities, a system that adds little bulk and mass may be desirable. In addition, the system and method described herein can be adapted to a wide variety of plugs and sockets, and to a wide variety of portable electronic devices, accessories, connectors and the like.

Further, it has been learned through experimentation that such a system for detecting a proper cable connection may be more durable than a conventional system, and may be less susceptible to breakage (and costly need for repair). Consequently, the long-term cost of a pressure-based detection system, when compared to a mechanical detection system, may be comparable or lower over the lifetime of the system. In contrast to a mechanical switch, interaction between the moving parts and a pressure sensor does not necessarily involve any physical contact between the moving parts and the sensor. Consequently, there may be expected significantly less wear and tear on a pressure sensor in comparison to a mechanical switch over time.

In some circumstances, the concepts described herein may entail a cost not present with other systems, but which may realize benefits in exchange for that cost. For example, although a mechanical switch does not require power to be activated, such a switch does result in power consumption when the switch is activated. In comparison, the pressure sensor may consume power to detect a change in pressure, but the power consumption is small.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. An electronic device comprising:
a socket for receiving a plug;
a pressure sensor located in the socket configured to generate a pressure signal; and
a processor operatively connected to the pressure sensor, the processor configured to determine whether there has been a proper cable connection as a function of the pressure signal.

2. The electronic device of claim 1, wherein the pressure signal is a function of air pressure within the socket.

3. The electronic device of claim 1, wherein the pressure signal is a function of a contact pressure.

4. The electronic device of claim 1, further comprising:
a validating component operatively connected to the processor,
wherein the plug comprises an inner pin and an outer pin, and wherein the validating component is configured to supply to the processor a resistance signal as a function of a resistance between the inner pin and the outer pin.

5. The electronic device of claim 1, wherein the socket comprises a proximal end and a distal end, and wherein the pressure sensor is located proximate to the proximal end.

6. The electronic device of claim 1, wherein the pressure sensor is a silicon based pressure sensor.

7. The electronic device of claim 1, wherein the pressure sensor is a microelectromechanical system based pressure sensor.

8. The electronic device of claim 1, wherein the pressure sensor is an ink based pressure sensor.

9. The electronic device of claim 2, wherein the processor is configured to control the pressure sensor to generate a plurality of pressure signals at a sampling frequency.

10. A method comprising:
controlling a sampling of an air pressure inside a socket at a first sampling frequency;
receiving a first pressure signal as a function of the air pressure;
in response to the first pressure signal, controlling the sampling of the air pressure inside the socket at a second sampling frequency;
receiving a plurality of pressure signals at the second sampling frequency; and
determining when a proper cable connection of the socket and a plug has been made as a function of the plurality of pressure signals.

11. The method of claim 10, wherein receiving the first pressure signal as a function of the air pressure comprises receiving the first pressure signal as a function of the change in the air pressure.

12. The method of claim 10 further comprising:
prior to determining whether the proper cable connection has been made, determining that the proper cable connection is lacking; and
generating a notification to a user.

13. The method of claim 10, further comprising, prior to controlling the sampling of the air pressure inside the socket at the second sampling frequency, comparing the first pressure signal to a threshold; and
controlling the sampling of the air pressure inside the socket at the second sampling frequency when the first pressure signal exceeds the threshold.

14. The method of claim 10, wherein the plug comprises an inner pin and an outer pin, the method further comprising:
receiving a resistance signal as a function of a resistance between the inner pin and the outer pin; and
determining whether a proper cable connection of the socket and a plug has been made as a function of the resistance signal.
